(19) United States
(12) Patent Application Publication
(10) Pub. No.: US 2026/0157257 A1
(43) Pub. Date: Jun. 11, 2026

(54) ROW GUIDANCE USING SENSOR DATA FUSION

(71) Applicant: Deere & Company, Moline, IL (US)

(72) Inventors: Tarik LOUKILI, URBANDALE, IA (US); Joel J. SANDOVAL, Ankeny, IA (US); Michael L. RHODES, Richfield, MN (US)

(21) Appl. No.: 18/977,285

(22) Filed: Dec. 11, 2024

(51) Int. Cl. A01B 69/00; A01B 69/04; G06V 10/80; G06V 20/56

(52) U.S. Cl. CPC A01B 69/001; A01B 69/008; G06V 10/80; G06V 20/56

(57) ABSTRACT

A mobile work machine includes a row alignment control system that identifies a correction operation to bring the mobile work machine into alignment with a plurality of crop rows in an area of crops. The row alignment control system identifies the correction operation based at least in part on a comparison of how a shift in the plurality of crop rows affects data gathered by two sensors on the mobile work machine that capture data indicative of the area of crops. A control system controls the mobile work machine using a control signal generated by the row alignment control system based on the identified correction operation.

### FIELD OF THE DESCRIPTION

The present description relates to mobile work machines. More specifically, the present description relates to fusing data from multiple sensors to support actively aligning at least a portion of a moving mobile work machine with a plurality of crop rows.

### BACKGROUND

Maintaining alignment of machinery with crop rows is desirable for various reasons, such as optimizing efficiency and preventing crop damage. Historically, mechanical systems such as physical feelers have been used to detect crop rows and support guidance of machinery along them. These feelers, which make direct contact with crops, are limited in their ability to provide effective guidance, particularly in irregular crop conditions.

The discussion above merely provides general background information and is not intended to be used to aid in determining the scope of the claimed subject matter.

### SUMMARY

A mobile work machine includes a row alignment control system that identifies a correction operation to bring the mobile work machine into alignment with a plurality of crop rows in an area of crops. The row alignment control system identifies the correction operation based at least in part on a comparison of how a shift in the plurality of crop rows affects data gathered by two sensors on the mobile work machine that capture data indicative of the area of crops. A control system controls the mobile work machine using a control signal generated by the row alignment control system based on the identified correction operation.

### BRIEF DESCRIPTION OF THE DRAWINGS

FIG. 1 is a side diagrammatic view of a mobile work machine.

FIG. 2 is a schematic representation of the mobile work machine in an example field environment that includes two crop rows.

FIG. 3 is a schematic representation of the mobile work machine in another example field environment that includes two crop rows.

FIG. 4 is a schematic representation of the mobile work machine in an example field environment that includes four crop rows.

FIG. 5 is another schematic representation of the mobile work machine in the example field environment that includes four crop rows.

FIGS. 6A and 6B are schematic representations of the mobile work machine in the example field environment that includes four crop rows.

FIG. 7 is a schematic representation of the mobile work machine in the example field environment that includes four crop rows.

FIG. 8 is a schematic block diagram of an example environment in which the mobile work machine operates.

FIG. 9 is a block process diagram that presents an example of a crop row alignment process.

FIG. 10 is a block diagram showing one example of the mobile work machine deployed in a remote server architecture.

FIGS. 11-13 are examples of mobile devices used in environments shown in the previous figures.

FIG. 14 is a block diagram showing one example of a computing system used in environments shown in the previous figures.

### DETAILED DESCRIPTION

As discussed above, mechanical systems such as physical feelers have been used to directly contact the crop plants to detect crop rows to support machine alignment. However, as discussed above, these feelers are limited in their ability to provide effective guidance, particularly in irregular crop conditions. Moreover, these feelers cannot very well anticipate changes in row position ahead of the machine, leading to delayed corrective actions and less precise alignment. As machinery becomes more sophisticated and field conditions more complex, there is a need to effectively overcome the drawbacks of physical feelers or similar systems. Maintaining alignment with crop rows is essential for various agricultural machines, including harvesters, sprayers, and other row-based equipment. Misalignment can happen, especially when a dense crop canopy structure limits the field of view. Misalignment can lead to wasted resources, such as fuel, chemicals, or time, and reduce the overall effectiveness of an agricultural operation, such as harvesting, spraying, etc. Therefore, the present description presents a row alignment control system that operates with row alignment detection hardware to support actively aligning at least a portion of a moving mobile work machine with a plurality of crop rows.

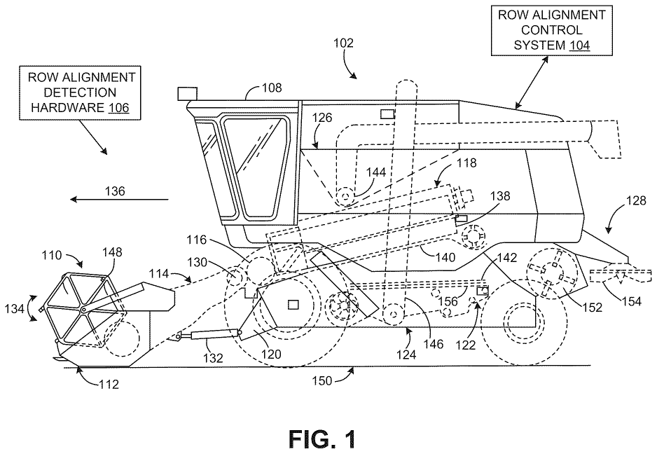

FIG. 1 is a side diagrammatic view of a mobile work machine 102 with an associated row alignment control system 104 and row alignment detection hardware 106. Mobile work machine 102, as shown in FIG. 1, is a combine harvester. However, concepts described herein could just as easily be applied to other types of machines, such as cotton harvesters, sugarcane harvesters, self-propelled forage harvesters, windrowers, sprayers, or other mobile work machines. Examples of other mobile work machines also include fully or partially autonomous rather than manually operated machines.

Mobile work machine 102 illustratively includes an operator compartment 108, a header 110, a cutter 112, a feeder house 114, a feed accelerator 116, a thresher 118, a chassis 120, a cleaning subsystem 122, a material handling subsystem 124, a clean grain tank 126, and a residue subsystem 128. Operator compartment 108 illustratively accommodates various operator interface mechanisms (including but not limited to such devices as a steering wheel, pedals for speed control and braking, levers and buttons for machinery control, communications equipment, networking devices, etc.) for controlling mobile work machine 102. Control of mobile work machine 102 is illustratively performed by a human situated inside operator compartment 108. In addition, or alternatively, control of mobile work machine 102 is conducted by an operator that is a remotely situated human operator, an automated system, a semi-automated system, etc.

In one example, mobile work machine 102 moves forward while harvesting a crop, as indicated by arrow 136. Header 110 is pivotally coupled to chassis 120 along a pivot axis 130. Actuator(s) 132 illustratively drive the movement of header 110 about pivot axis 130 in the direction indicated by arrow 134. Thus, a vertical position of header 110 (i.e., header height) above ground 150 is controllable by actuating actuator(s) 132. The vertical position is illustratively controlled manually by a human operator in the cab or remotely situated, by onboard hardware and/or software, or remotely by an autonomous or semi-autonomous system.

Reel 148, associated with header 110, illustratively engages crops to be harvested by passing the crops through dividers (not shown) to gather the crops into bundles as the crops travel toward cutter 112. Upon reaching cutter 112, the bundles are cut based on a height of header 110, which is set as described above. The cut crops are moved through a conveyor (not shown) in feeder house 114 toward feed accelerator 116, which moves the cut crops into thresher 118. Thresher 118 illustratively separates grain from plants by rotating the crops against metal plates called concaves 138. Separator 140 separates chaff and other residue from the grains in threshed crop material, where at least a portion of the residue is moved toward residue subsystem 128.

To capture the grains, cleaning subsystem 122 illustratively receives the grains, where a chaffer 142 separates some larger pieces of non-needed plant material from the grains. A sieve 156 (only generally shown) illustratively separates some finer pieces of the non-needed plant material from clean grains. In one example, an auger 144 receives and moves the clean grains to an inlet end (not shown) of a clean grain elevator 146 that deposits the clean grains in clean grain tank 126.

Unwanted portions of the crops are routed to residue subsystem 128, which includes a residue chopper 152 to chop stalks and straw into smaller pieces before a spreader 154 spreads smaller pieces onto the field. In some examples, residue subsystem 128 releases the residue through a long line of heaped material known as a windrow, which will illustratively be picked up later by another work machine. In other examples, residue subsystem 128 includes a weed seed eliminator (not shown), such as a seed bagger and a seed crusher.

Some machines similar to mobile work machine 102 are outfitted with feelers linked to software that supports steering correction in an autonomous or semi-autonomous manner. The feelers typically extend outwardly from a leading side of crop dividers on the header. As the mobile work machine moves through a field while harvesting row crops, for example, plant stalks push against one or more of the feelers, causing a rearward deflection. The rearward deflection causes a sensor to provide a signal indicative of a relative location of plant stalks with respect to the crop dividers. Software linked to the feelers supports generation of corresponding steering signals chosen to support a centering of the row crops between adjacent crop dividers. A disadvantage of utilizing a feelers configuration is that the technology is not forward-looking. Essentially, the feelers can only react once a problem is encountered, for example, once a plant(s) is missed.

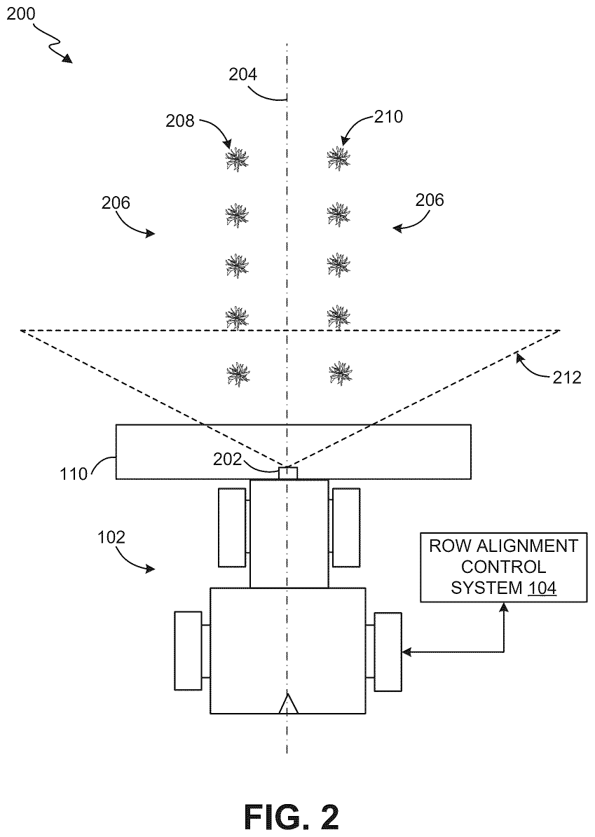

FIGS. 2-7 are schematic representations of mobile work machine 102 in example field environments. Labeled elements assigned same or similar numbers throughout the present description are assumed to have same or similar features or functions. FIGS. 2-7 provide different examples of row alignment detection hardware 106 that, together with row alignment control system 104, support crop row alignment functions for mobile work machine 102.

Referring to FIG. 2, mobile work machine 102 operates in a field environment 200. FIG. 2 is a simplified depiction showing only a pair of crop rows 208 and 210, each containing crops 206 in the process of being harvested. In another example, crop rows 208 and 210 will have additional crop rows similarly spaced to left and right of crop rows 208 and 210, respectively. In other examples, mobile work machine 102 will harvest at a width of four or even more crop rows at one time instead of just two.

In the example of FIG. 2, row alignment detection hardware 106 (depicted in FIG. 1 only) includes an image sensing device 202, such as a camera or image sensor, positioned on mobile work machine 102. Image sensing device 202 illustratively captures one or more images of the portion of field environment 200 in front of mobile work machine 102, within a field of view 212. Row alignment control system 104 illustratively receives and processes image(s) to extract data indicative of at least a portion of crops 206. Further, row alignment control system 104 is configured, in one example, to identify crop rows 208 and 210 from the images. Furthermore, row alignment control system 104 illustratively utilizes the crop and/or crop row information to indicate machine-to-crop alignment. As mobile work machine 102 moves forward and actively harvests crops 206, row alignment control system 104 illustratively repeats machine-to-crop alignment determinations on a periodic, or intermittent, or even nearly constant, basis. Based on these determinations, the row alignment control system 104 illustratively supports calculation of correction operations to support a centering of at least a portion of the mobile work machine 102 relative to the crop rows 208 and 210. For instance, but not by limitation, calculated correction operations support a centering of an axis 204 (illustratively a longitudinal axis) of the mobile work machine 102 relative to the crop rows. In other examples, calculated correction operations can support centering of other portions or components of the mobile work machine 102 relative to the crop rows such as, but not limited to, wheels or tracks of mobile work machine 102, an implement (or components thereof) of mobile work machine 102, as well as various other portions or components. One example of a correction operation is a steering signal that is autonomously effectuated, semi-autonomously effectuated, or even manually effectuated in response to information on a user interface.

Accordingly, image sensing device 202 and row alignment control system 104 provide look-ahead capability by detecting shifts in the position of crop rows (e.g., crop rows 208 and 210, even multiple plants ahead in each crop row) relative to mobile work machine 102 in time for calculating effective correction operations. However, as crops 206 grow and a canopy develops (e.g., due to outgrowth, especially when rows are planted close together), the accuracy of row detection naturally decreases due, for example, to some portions of crops 206 becoming less visible to image sensing device 202. For this and other reasons (e.g., poor lighting conditions, heavy dust, etc.), image sensing device 202 sometimes struggles to support accurate alignment.

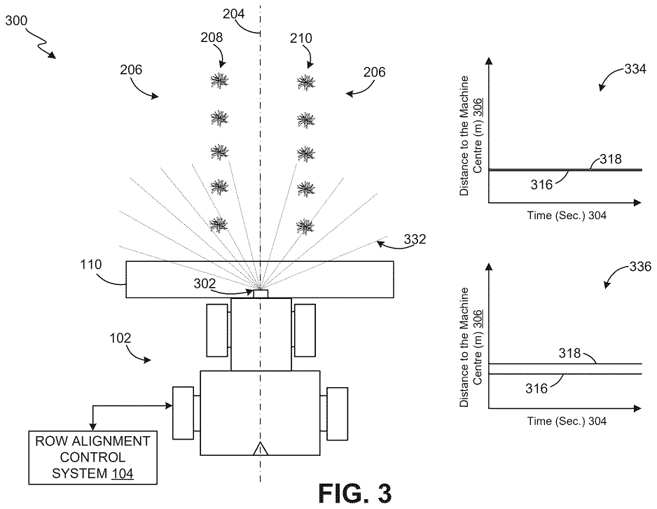

Referring to FIG. 3, mobile work machine 102 is depicted operating within a field environment 300. In this example, row alignment detection hardware 106 (depicted in FIG. 1 only) comprises a radar sensor 302 mounted on the mobile work machine 102. Radar sensor 302 illustratively emits radar waves 332 that encounter crops 206 in front of mobile work machine 102, enabling detection of crop stalks even in conditions where dense canopy cover obstructs visual detection. For example, radar sensor 302 emits radar waves 332 at a crop-penetrating frequency. This allows scanning a field region ahead of mobile work machine 102 and profiling the crop stalks (even multiple plants deep in each crop row), thereby facilitating accurate detection of crop rows 208 and 210.

In another example, radar sensor 302 is a polarized radar sensor configured to emit polarized waves to enhance crop row detection. Polarization of the radar waves illustratively further reduces interference from leaves and other extraneous vegetation, providing a potentially clearer signal of the position of the stalks of crops 206. The radar sensor 302 is mountable in various locations, including but not limited to being mounted on a front bumper with its antenna of radar sensor 302 pointing ahead.

The data captured by the radar sensor 302 is illustratively processed by the row alignment control system 104, which determines a position of all or a portion of the mobile work machine 102 relative to crop rows 208 and 210. In one example, row alignment control system 104 illustratively utilizes the crop and/or crop row information to indicate machine-to-crop alignment. As mobile work machine 102 moves forward and actively harvests crops 206, row alignment control system 104 illustratively repeats machine-to-crop alignment determinations intermittently, on a periodic, or even nearly constant, basis. Based on these determinations, the row alignment control system 104 illustratively supports the calculation of correction operations essential to support a centering of at least a portion of the mobile work machine 102 relative to crop rows 208 and 210. In one example, the correction operation is a steering signal that is autonomously effectuated, semi-autonomously effectuated, or even manually effectuated in response to information on a user interface.

Referring to FIG. 3, an example of data output from radar sensor 302 is represented in two graphs, 334 and 336, which illustrate measurements captured by radar sensor 302. In both graphs, x-axis 304 represents time in seconds, and y-axis 306 represents a distance from machine center to the detected crop rows 208 and 210.

Graph 334 contains two plot lines, 316 and 318. Plot line 316 represents the distance over time from machine center to one of the crop rows 208 or 210, though which of the two crop rows 208 or 210 is illustratively unknown from the perspective of radar sensor 302. Plot line 318 represents the distance over time from machine center to one of the crop rows 208 or 210, though which of the two crop rows 208 or 210 is illustratively unknown from the perspective of radar sensor 302. Though radar sensor 302 is effectively uninformed as to which measurement goes with which crop row, close proximity of plot lines 316 and 318 signal that alignment is being maintained over time (i.e., because the distance from the center of machine 102 to the crop rows 208 and 210, in either case, is the same or close to the same).

By contrast, graph 336 shows plot lines 316 and 318 as having diverged, signaling a misalignment between machine center and crop rows 208 and 210. In this case, one of the crop rows, 208 or 210, is now farther from machine center than the other. While this data from radar sensor 302 is illustratively enough to support a determination of a magnitude of a shift (i.e., how far), there is illustratively not enough information for radar sensor 302 to support a determination of a direction of the shift (i.e., left or right relative to the crop rows 208 and 210). In one example, a direction is selected automatically, semi-automatically with assistance from an operator, or manually by an operator. If incorrect, alignment is not efficiently achieved. Based on data from radar sensor 302 alone, effectively selecting the correct direction for a correction operation is a challenge.

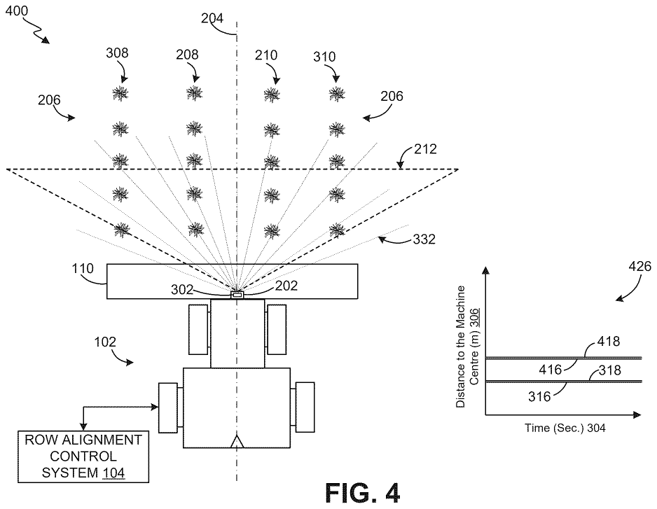

Referring to FIG. 4, mobile work machine 102 is depicted operating within a field environment of 400. In FIG. 4, row alignment detection hardware 106 (depicted in FIG. 1 only) includes an image sensing device 202 and a radar sensor 302. Crops 206, for illustrative purposes, are organized into four crop rows. Thus, FIG. 4 illustrates an expanded setup with four crop rows, 208, 210, 308, and 310, as opposed to a simplified two crop row configuration shown in previous Figures.

Image sensing device 202 is mounted on mobile work machine 102 and has a field of view 212. Image sensing device 202 captures images of crops ahead (illustratively, but not necessarily multiple plants deep in each crop row). These images are processed by row alignment control system 104, which illustratively determines information related to a lateral position of mobile work machine 102 relative to crop rows 208, 210, 308, and 310. Radar sensor 302, also mounted on mobile work machine 102, emits radar waves interacting with the crops 206 (illustratively, but not necessarily multiple plants deep in each crop row). In one example, radar sensor 302 provides distance measurements to crop stalks, which are provided to row alignment control system 104 for consideration and processing. Radar sensor 302 is illustratively useful when a crop canopy obstructs image sensing device 202, allowing the row alignment control system 104 to maintain a source of relatively reliable row detection data through radar-based measurements even in low visibility conditions.

An example of data captured by radar sensor 302 is represented in graph 426, which shows distance to machine center over time. Graph 426 includes four plot lines 316, 318, 416, and 418. Plot lines 316 and 318 correspond to distances from machine center to crop rows 208 and 210, respectively. In contrast, plot lines 416 and 418 represent distances from machine center to crop rows 308 and 310, respectively. In this example, the plot lines reflect a symmetry about the central axis 204 of mobile work machine 102, signaling that mobile work machine 102 is aligned. The uniformity of the distances in graph 426 signals that mobile work machine 102 remains at least close to evenly positioned relative to the crop rows as it operates over time.

In one example, radar sensor 302 and image sensing device 202 are configured for coordination. Each illustratively provides alignment data utilized selectively (e.g., manually or semi-automatically selected) or preferentially (e.g., automatically or otherwise programmatically selected based on programmatically applied criteria) based on field conditions, etc. For example, in early growth stages of crops 206, where visibility is high, image sensing device 202 alone is illustratively relied upon to provide sufficient information to determine both a magnitude and direction for correction operations. Conversely, when the crop canopy becomes dense and obstructs the field of view 212 of image sensing device 202 (or if heavy dust becomes a problem, or if lighting conditions are less than ideal, etc.), radar sensor 302, in one example, is illustratively switched to as a primary source of data for supporting at least a magnitude for correction operations. In one example, image sensing device 202 illustratively is configured to continue operating as a primary source for directional data.

In another example, radar sensor 302 and image sensing device 202 are configured to provide data used by row alignment control system 104 so as to support a corroborative approach. In one specific example of this, row alignment control system 104 is configured to cross-reference data from both sensors to enhance detection accuracy. If discrepancies arise between data provided by image sensing device 202 and radar sensor 302, row alignment control system 104 illustratively detects potential errors and effectuates adjustments to crop row alignment calculations accordingly.

In another example, row alignment control system 104 is configured to average or otherwise blend data from radar sensor 302 and image sensing device 202, providing a balanced approach. In one specific example of this, row alignment control system 104 assigns different weights to data from data sources based on confidence metrics, conditions of the field environment, etc. For instance, in high-visibility conditions, data from image sensing device 202 is illustratively given more weight, whereas, in low-visibility conditions (e.g., caused by dense crop canopies, etc.), the data from radar sensor 302 is illustratively prioritized.

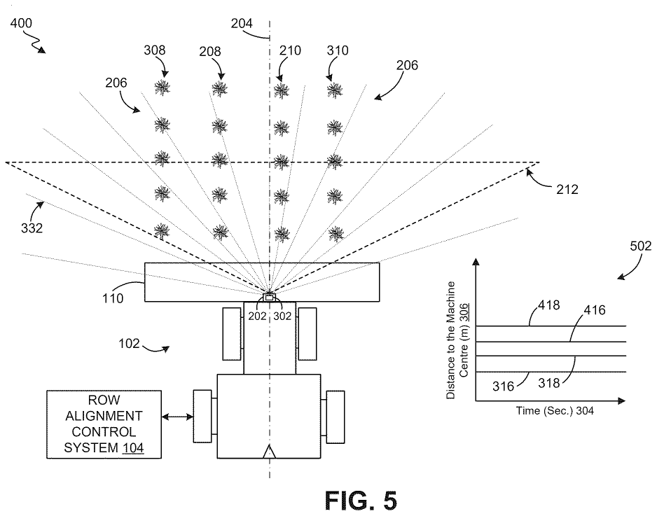

Referring to FIG. 5, mobile work machine 102 is again depicted operating within field environment 400. Like FIG. 4, row alignment detection hardware 106 (depicted in FIG. 1 only) includes image sensing device 202 and radar sensor 302, which provide data to row alignment control system 104 to support alignment operations. However, crop rows 208, 210, 308, and 310 in this example have shifted slightly to the left relative to the central axis 204 of mobile work machine 102.

A new graph 502 is an example of the data now captured by radar sensor 302. This graph, like graph 426 in FIG. 4, has time represented along the x-axis 304 and distance to machine center represented along the y-axis 306. Graph 502 again includes four plot lines: 316, 318, 416, and 418. Plot lines 316 and 318 correspond to distances from machine center to crop rows 208 and 210, respectively, while plot lines 416 and 418 represent distances from machine center to crop rows 308 and 310, respectively. In contrast to FIG. 4, where the plot lines were symmetrical, therefore signaling proper alignment, the plot lines in FIG. 5 reflect a shift of crops 206 to the left. As a result of this shift, plot lines 316, 318, 416, and 418 reflect different distances over time, indicating that mobile work machine 102 is no longer in alignment.

Data as reflected in graph 502 illustratively enables row alignment control system 104 to detect shift and initiate appropriate responsive action. In one example, based on the radar data, row alignment control system 104 determines lateral adjustments effective to realign mobile work machine 102 with the crop rows. Data from radar sensor 302 is illustratively used independently or in combination with the data from image sensing device 202 to determine a magnitude of a responsive correction. However, data from the radar sensor 302 is, at least in some examples, not enough to know clearly in which direction a responsive correction is to be carried out. As was discussed in relation to FIG. 4, outputs from radar sensor 302 and image sensing device 202 are, in some examples, fused to support row alignment control system 104 in determination of appropriate corrective action, including both a magnitude and direction for corrective operations.

In one example, an initial calibration establishes a starting assumption of proper alignment between mobile work machine 102 and crops 206. This calibration process in different examples is performed in various ways, depending on system configuration and field conditions. In one example, the calibration is automatic, whereas in row alignment control system 104, sensor data is used to determine an ideal alignment without user intervention. In another example, the calibration is semi-automatic, requiring limited user input to adjust or confirm the alignment. In still another example, the calibration process is manually accomplished by the operator, who visually or through external measurements ensures that mobile work machine 102 is correctly positioned relative to the crop rows before initiating machine-to-crop alignment determinations. Initial calibration illustratively provides a reliable baseline for subsequent operations.

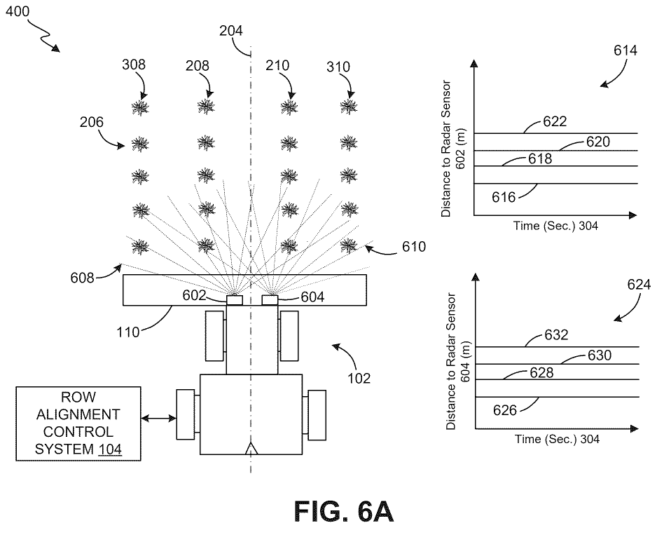

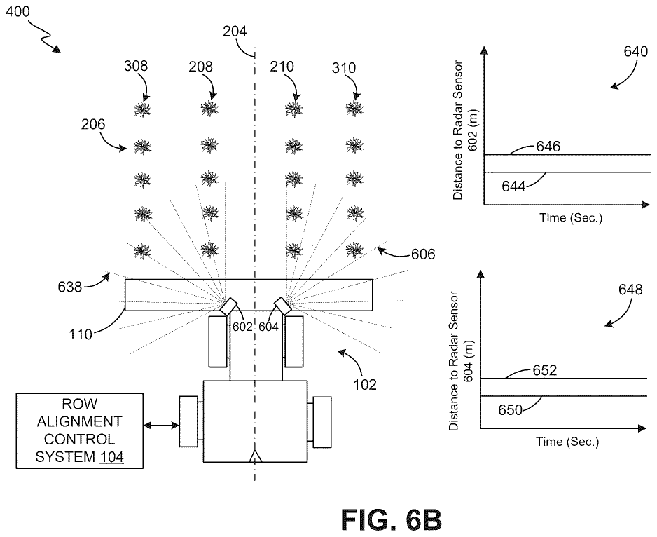

Referring to FIG. 6A, mobile work machine 102 operates in field environment 400, similar to FIGS. 4 and 5, but with a different configuration of row alignment detection hardware 106 (depicted in FIG. 1 only). In this example, the combination of image sensing device 202 and radar sensor 302 has been replaced with a combination of a first radar sensor 602 and a second radar sensor 604. The first radar sensor, 602, is positioned to the left of central axis 204, while the second radar sensor, 604, is positioned to the right of central axis 204. Utilizing two separate radar sensors, illustratively though not necessarily spaced apart as shown, provides row alignment control system 104 with sufficient data to support calculation of both a distance and direction for corrective actions, etc. In this scenario, a non-radar data source, such as image sensing device 202, is not a requisite. However, in one example, it can still be included for corroborative or other purposes.

FIG. 6A includes two graphs that represent radar-based distance measurements over time. Graph 614 presents an example of data captured by first radar sensor 602, which is illustratively configured to measure a distance to each of crop rows 308, 208, 210, and 310 by emitting radar waves 608 and capturing reflected waves. Notably, the y-axis of graph 614 is now the distance to the first radar sensor 602, while the x-axis 304 continues to represent time. Consequently, graph 614 contains four plot lines, 622, 620, 618, and 616, each showing a different measured distance over time due to the positioning of the first radar sensor 602 relative to crops 206. In the example shown in graph 614, mobile work machine 102 is illustratively maintaining a balanced alignment over time relative to crop rows 308, 208, 210, and 310, with the four plot lines representing distinct, consistent measurements.

Graph 624 presents an example of data captured by second radar sensor 604, which is also illustratively configured to measure the distance to each of crop rows 308, 208, 210, and 310 by emitting radar waves 610 and capturing reflected waves. Notably, the y-axis of graph 624 is now the distance to the second radar sensor 604, while the x-axis 304 continues to represent time. Consequently, graph 624 contains four plot lines, 632, 630, 628, and 626, each showing a different measured distance over time due to the positioning of the second radar sensor 604 relative to crops 206. In the example shown in graph 624, mobile work machine 102 is illustratively maintaining a balanced alignment over time relative to crop rows 308, 208, 210, and 310, with the four plot lines representing distinct, consistent measurements.

In the event of a shift in the rows of crops 206, a pattern of data captured by first and second radar sensors 602 and 604 (and therefore reflected in graphs 614 and 624) will illustratively change. Programmed to account for relative positions of first and second radar sensors 602 and 604, row alignment control system 104 is illustratively configured to support the processing of such changes to programmatically determine both the magnitude and direction of a shift in the rows in crops 206. For example, a programmatic comparison of a difference in distance measurements by first and second radar sensors, 602 and 604 provides enough context to support a shift direction determination.

In a more specific example, a shift illustratively causes crop rows 308 and 208 (plot lines 616 and 618, the two shorter measurements as detected by first radar sensor 602) to move farther from first radar sensor 602, while crop rows 210 and 310 (plot lines 626 and 628, the two shorter measurements as detected by second radar sensor 604) to move closer to second radar sensor 604. Row alignment control system 104 has enough information to support a programmatic determination of the shift direction in the rows of crops 206. Row alignment control system 104 can also support the programmatic determination of the magnitude of the shift with the information provided.

Referring to FIG. 6B, mobile work machine 102 operates in field environment 400, similar to FIGS. 4 and 5, but with a different configuration of row alignment detection hardware 106 (depicted in FIG. 1 only). In example shown in FIG. 6B, first and second radar sensors 602 and 604 again are utilized but have been reconfigured to measure different crop rows, i.e., to measure crops 206 on their respective side of the central axis 204 of the mobile work machine 102. For instance, the first radar sensor 602 emits radar wave 638 towards crop rows 208 and 308 and captures reflected waves, while the second radar sensor 604 emits radar wave 606 towards crop rows 210 and 310 and captures reflected waves. Utilizing two separate radar sensors, illustratively though not necessarily precisely spaced part as shown, provides the row alignment control system 104 with sufficient data to support calculations of both a distance and direction for corrective actions, etc. It is still also capable of doing so without reliance on a non-radar data source, such as image sensing device 202.

FIG. 6B includes two graphs that represent radar-based distance measurements over time. Graph 640 presents an example of the data captured by first radar sensor 602, which is illustratively configured to measure a distance to every single crop row 308 and 208. Notably, y-axis 306 of graph 640 is again the distance to the first radar sensor 602, while x-axis 304 continues to represent time. Consequently, graph 640 contains two plot lines, 644 and 646, each showing a different measured distance over time due to the positioning of the first radar sensor 602 relative to crop 206. In the example shown in graph 640, mobile work machine 102 is illustratively maintaining a balanced alignment over time relative to crop rows 308, 208, 210, and 310, with the two plot lines representing distinct, consistent measurements.

Graph 648 presents an example of data captured by second radar sensor 604, which is also illustratively configured to measure the distance to every single crop rows 210 and 310. Notably, y-axis of graph 648 is now the distance to the second radar sensor 604, while x-axis 304 continues to represent time. Consequently, graph 648 contains two plot lines, 650 and 652, each showing a different measured distance over time due to the positioning of the second radar sensor 604 relative to crop 206. In the example shown in the graph, mobile work machine 102 is illustratively maintaining a balanced alignment over time relative to crop rows 308, 208, 210, and 310, with the two plot lines representing distinct, consistent measurements.

In the event of a shift in the rows of crops 206, the pattern of data captured by first and second radar sensors 602 and 604 (and therefore reflected in graphs 640 and 648) will illustratively change. Programmed to account for the relative positions of first and second radar sensors 602 and 604, row alignment control system 104 is illustratively configured to support the processing of such changes to programmatically determine both the magnitude and direction of the shift in the rows of crops 206. For example, a programmatic comparison of a difference in distance measurements by two separate radar sensors, 602 and 604, provides enough context to support a shift direction determination.

In a more specific example, a shift illustratively causes crop rows 308 and 208 (plot lines 644 and 646, the two measurements as detected by first radar sensor 602) to move farther from first radar sensor 602, while crop rows 210 and 310 (plot lines 650 and 652, the two measurements as detected by second sensor 604) to move closer to second radar sensor 604. Row alignment control system 104 has enough information to support a programmatic determination of the shift direction in the rows of crops 206. Row alignment control system 104 can also support the programmatic determination of the magnitude of the shift with the information made available.

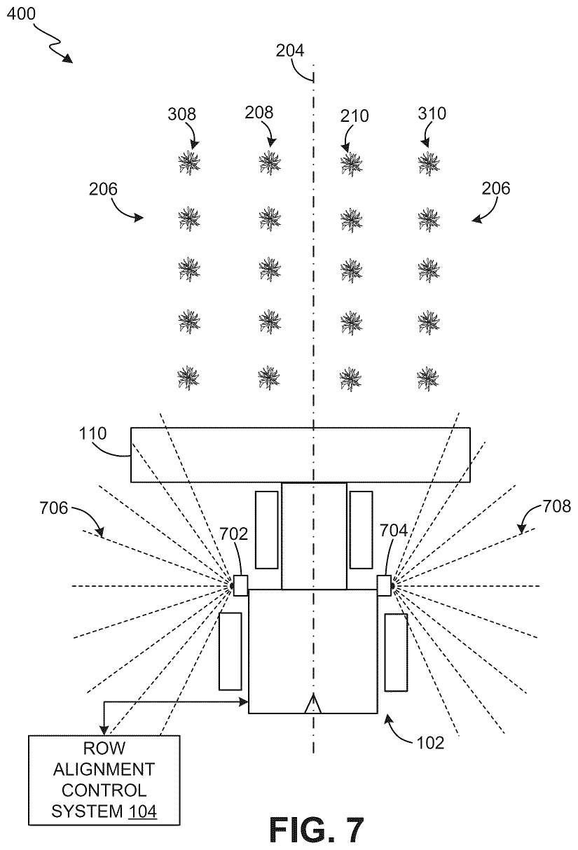

Referring to FIG. 7, mobile work machine 102 operates in field environment 400, similar to previous figures, but with a different configuration of row alignment detection hardware 106 (depicted in FIG. 1 only). In this example, two radar sensors, 702 and 704, are positioned differently than in FIGS. 6A and 6B. Radar sensor 702 is located on the first side of the mobile work machine 102, scanning outward, generally perpendicular to the direction of travel during the harvesting of crops 206. Radar sensor 704 is located on the other side, i.e., the opposite side, of mobile work machine 102 and is similarly oriented, scanning outward in the opposite direction to the scanning of radar sensor 702.

A radar sensor configuration is shown in FIG. 7 illustrates that, in some examples, radar sensors 702 and 704 are positioned to scan in directions other than directly in front of mobile work machine 102 while still providing sufficient data for row alignment control system 104 to support programmatic calculations indicative of both a magnitude and direction of desired corrective actions. By positioning radar sensors 702 and 704 on opposite sides of mobile work machine 102, for example, the operations of radar sensor are focused on measuring the distance to crop rows that are adjacent to the sides of mobile work machine 102 rather than in front of it. For instance, radar sensor 702 emits radar wave 706 towards crop rows (not shown) on the left side of mobile work machine 102 and captures reflected waves. In contrast, radar sensor 704 emits radar wave 708 towards crop rows (not shown) on the right side and captures reflected waves. In this configuration, row alignment control system 104 still gathers enough data to support both shift direction and magnitude determinations programmatically.

Radar sensors (e.g., radar sensors 302, 602, 604, 702, 704, 826) and image sensing devices (e.g., 202, 828) described herein are shown in the Figures as being mounted in various locations. These locations are only examples of mounting locations that should not be considered limiting. Further, the radar sensor(s) and image sensing device(s) are described or at least alluded to as being mounted so as to support a particular point of view (e.g., image sensing device 202 in one example is mounted with a point of view angled down toward crops 206). It is to be understood that any incorporated radar sensor or imaging device can be positioned so as to support a point of view that is most desirable for a given implementation, and is adaptable, in one example, at least to various aspects of crops 206, especially characteristics of an associated crop canopy.

A point of view of an incorporated radar sensor in some applications is illustratively high (e.g., where it is more likely to incorporate crop canopy features), in other applications is illustratively low (e.g., where crop canopy features are less likely included), and in some applications located is illustratively in between high or low. In one example, without regard to point of view, an incorporated radar sensor is configured to penetrate canopy or similar features manifested by the fact that that variations in return signal strength correlate to a density of crop features. Accordingly, by programmatically identifying and following higher density features, visual obstruction of stems or other crop features is not an impediment to analysis. In comparison, image sensing devices require unobstructed crop feature edges and other distinct visual delineation of crop features for effective identification of crop rows. Accordingly, a radar sensor's capacity to interpret crop feature density, rather than relying solely on edge detection, offers unique advantages to row alignment, especially for certain crop types or growth stages where canopy coverage is significant.

Radar sensors (e.g., radar sensors 302, 602, 604, 702, 704, 826) and image sensing devices (e.g., 202, 828) described herein can be mounted at any elevation relative to a ground surface and relative to crops 126 or features thereof. In one example, a radar and/or image sensor is positioned beneath a canopy level such that its point of view is focused completely or in large part on a stalk portion of crops. In another example, one or more sensors are mounted higher so as to provide a more comprehensive, top-down perspective. By positioning sensors in versatile locations and orientations, flexibility is accommodated as a compliment to a wide array of agricultural scenarios, ensuring optimal alignment through foliage penetration or visual tracking as required by the specific crop density or canopy characteristics.

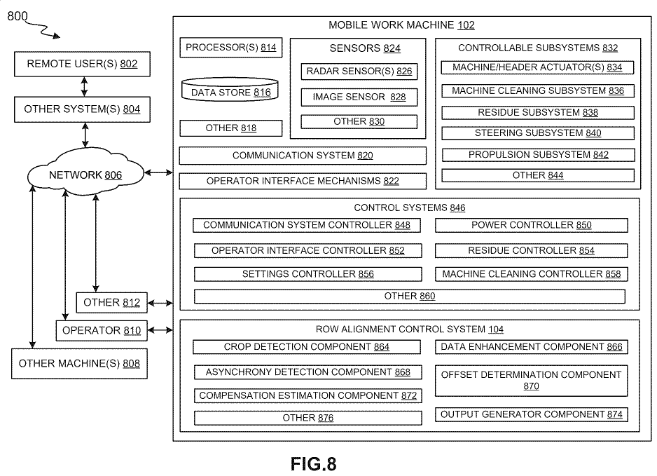

FIG. 8 is a schematic block diagram of an example environment 800 where mobile work machine 102 operates. Again, items assigned the same or similar numbers throughout the present description, compared to other Figures, are assumed to have similar features and functions. Example environment 800 includes mobile work machine 102, a remote user(s) 802, other system(s) 804, network 806, other machine(s) 808, operator 810, and can include other external systems or components as well, as indicated by block 812.

Remote user(s) 802 may or may not be located in a common worksite with mobile work machine 102. Remote user(s) 802 illustratively interacts with mobile work machine 102 through other system(s) 804. Other system(s) 804 can include various systems such as servers, computers, mobile electronic devices, or some other system or device. In one example, another system(s) 804 includes a subsystem for accessing data such as field plans, crop types, navigation details, or other data or information provided through network 806 by mobile work machine 102.

Other machine(s) 808 are illustratively, though not necessarily, located in a common field environment with mobile work machine 102. In one example, other machine(s) 808 include at least one other mobile work machine configured to perform a harvest related operation. Other machine(s) 808 are illustratively configured to support mobile work machine 102 interactions. In one example, other machine(s) 808 are equipped with a subsystem for accessing data such as field plans, crop types, navigation details, or other data or information provided through network 806 by mobile work machine 102 or otherwise.

Other system(s) 804 and other machine(s) 808 are communicatively connected, directly or indirectly, to mobile work machine 102 by way of (though not limited to) network 806. Network 806 is illustratively any of a variety of types of communications networks, such as but not limited to Bluetooth, Wi-Fi, cellular data, LAN, WAN, etc. Network 806 is substituted in some applications with a more direct, non-network-based connection, such as a cord-based connection.

Operator 810 illustratively controls or otherwise interacts with mobile work machine 102. In one example, operator 810 is a human operator that effectuates control of mobile work machine 102 by providing at least some inputs through a set of operator interface mechanisms 822 that are part of mobile work machine 102 (described in more detail below). Operator 810 illustratively receives feedback and information through, in one example, a user interface subsystem that is a part of mobile work machine 102. In another example, operator 810 also provides inputs for control of mobile work machine 102 (and/or receives feedback and information therefrom) through computing devices or systems separate from but connected to mobile work machine 102. Such devices or systems include server-based computer applications, computers, mobile electronic devices, etc.

In another example, operator 810, rather than a human operator, is a partially or fully programmatic operator configured to interact with and assert control over mobile work machine 102 and/or a subsystem thereof. This is the case, for example, when mobile work machine 102 is wholly or partially autonomous. In one example of this scenario, whole or at least some portions of operator 810 are implemented programmatically as a component of mobile work machine 102 and/or a remote computing system communicatively linked directly and/or remotely to mobile work machine 102 to effectuate a path at least in part for control and data/information feedback purposes.

Mobile work machine 102 itself includes a processor(s) 814, a data store 816, a communication system 820, operator input mechanisms 822, sensors 824, controllable subsystems 832, control systems 846, row alignment control system 104 and other items as well, as indicated by block 818. Illustratively, these components and systems are integrated components of mobile work machine 102. However, some (or even portions of some) of these components may be located and operate from a separate system that is remote or otherwise outside the natural boundary of mobile work machine 102 itself (e.g., configured to operate remotely from a server, from a separate computing device, from a cloud environment, from a different machine, etc.).

Processor(s) 814 includes one or more computer processors with associated memory and timing circuitry, not separately shown. Processor(s) 814 is a functional part of mobile work machine 102 and is activated by and facilitates the functionality of other components and related systems and subsystems of mobile work machine 102. Processor(s) 814 implements the logic and overall functionality as a requisite to support mobile work machine 102 operations.

Data store 816 stores various information and data that support operations and functionality of mobile work machine 102 and/or related systems or subsystems. Data store 816, in some examples, includes crop-related data, still images, moving images, radar data, machine kinematics data/dimension data, maps & map-related data, and is likely to include other items. In some examples, data store 816 is, fully or partially, disposed at a location remote from mobile work machine 102 and accessed remotely.

Machine kinematic/dimension data illustratively includes data related to displacement, motion, and orientation of various components of mobile work machine 102 and data related to dimensions and pivot points of various controllable subsystems and/or other components of mobile work machine 102. In one example, this data supports aligning header 110 for crops 206. Maps & map-related data illustratively includes field maps, navigation maps, position coordinates data, etc., for example, related to harvesting fields, etc.

Communication system 820 enables components of mobile work machine 102 to communicate with one another and over network 806, etc. Examples of communication system 820 are a controller area network (CAN), or other bus communication system and/or any other systems used to facilitate communications between components of mobile work machine 102 and/or over network 806. Communication system 820 acts as a central communication network that links various components of mobile work machine 102, enabling efficient data exchange, coordinated system operation, and fault detection. It ensures that different components and systems work together seamlessly, enhancing overall machine performance and reliability.

Operator 810 interacts with operator interface mechanism 822 in controlling various mobile work machine 102 operations. In some examples, operator interface mechanisms 822 include joysticks, levers, a steering wheel, linkages, pedals, buttons, dials, keypads, user actuatable elements (such as icons, buttons, etc.) on a user interface display device, a microphone, and speaker (where speech recognition and speech synthesis are provided), among a wide variety of other types of control devices. Where a touch-sensitive display system is provided, operator 810 interacts with operator interface mechanisms 822 using touch gestures. The examples described above are illustrative and are not intended to limit the scope of the present disclosure. Consequently, other types of operator interface mechanisms 822 are applicable and are within the scope of the present disclosure.

Controllable subsystems 832 are illustratively controlled at least in part by processor(s) 814 and/or other components of mobile work machine 102 to effectuate the performance of various mobile work machine 102 operations, e.g., driving, steering, scanning, aligning, etc. Controllable subsystems 832 illustratively include machine/header actuator(s) 834, a machine cleaning subsystem 836, a residue subsystem 838, a steering subsystem 840, and a propulsion subsystem 842. As indicated by block 844, other controllable subsystems are possible. For example, mobile work machine 102 will likely have safety and other subsystems.

Machine/header actuator(s) 834 illustratively drives movement control, machine positioning, and other functionality of mechanical components of mobile work machine 102. In some examples, machine/header actuator(s) 834, without limitation, control header height, header tilt, reel speed, reel position, gathering chain speed, etc. Such movements are important to mobile work machine 102 performing the harvesting operation or while performing a radar scanning operation.

Machine cleaning subsystem 836 illustratively executes a variety of cleaning operations of mobile work machine 102. For instance, based upon different types of seeds or weeds passed through mobile work machine 102, machine cleaning subsystem 836 controls a particular type of machine cleaning operation or the frequency with which a cleaning operation is performed.

In one example, residue subsystem 838 receives residue after thrashing, chops the residue, and spreads the chopped residue on the field. In one example, the residue is released via a windrow. In some examples, residue subsystem 838 includes weed seed eliminators such as seed baggers or other seed collectors, seed crushers, or other seed destroyers.

Steering subsystem 840 illustratively steers mobile work machine 102 while harvesting and/or moving around the field. In one example, operator 810 operates steering subsystem 840 and propulsion subsystem 842 to steer mobile work machine 102 along a desired path for operation. In some examples, propulsion subsystem 842 and steering subsystem 840 are controlled together based on programmed variables or other programmatic assumptions. For instance, as mobile work machine 102 approaches a sharper turn in a crop row path, propulsion subsystem 842 is controlled to reduce the speed of mobile work machine 102, and steering subsystem 840 is controlled to make a sharp turn simultaneously. In one example, operations of this nature are carried out to maintain alignment of part or whole of mobile work machine 102 with crop rows, illustratively crop rows 208-210 and 308-310.

Control systems 846, in one example, are configured to receive and process input data from operator interface mechanisms 822, sensors 824, or any other component(s) of the mobile work machine and then to generate one or more corresponding control signals to control one or more of controllable subsystems 832 or another component of mobile work machine 102. In another example, control systems 846 include a communication system controller 848, a power controller 850, an operation interface controller 852, a residue controller 854, a settings controller 856, and machine cleaning controller 858, and includes other controllers as well, as indicated in block 860.

Communication system controller 848 illustratively controls communication system 820 to enable components of mobile work machine 102 to communicate with one another or through network 806. In one example, communication system controller 848 controls communication system 820 to communicate data from row alignment detection hardware 106 to row alignment control system 104.

Operator interface controller 852, in one example, is operable to generate control signals to control at least one of operator interface mechanisms 822. In one example, the operator interface controller 852 is also operable to present data or information from row alignment detection hardware 106 and/or the output data or information from row alignment control system 104 to operator 810. For example, the operator interface controller 852 illustratively generates control signals to control a display mechanism to display data or information to operator 810, who then responds utilizing operator interface mechanism 822.

Settings Controller 856 illustratively facilitates the generation of control signals to control various settings (and therefore related functions, etc.) on mobile work machine 102. Examples of controllable settings include, but are not limited to, sieve and chaffer settings, thresher clearance, rotor settings, cleaning fan speed settings, header height, header functionality, reel speed, reel position or internal distribution control functions.

Residue controller 854 illustratively generates control signals to control residue subsystem 838, and machine cleaning controller 858 generates control signals to control machine cleaning subsystem 836. For instance, based upon the different types of seeds or weeds passed through mobile work machine 102, a particular type of machine cleaning operation or a frequency with which a cleaning operation is performed is controlled.

Power Controller 850 illustratively generates control signals to control power utilization within mobile work machine 102, where power is allocated to different subsystems. Generally, power utilization is increased or decreased, etc. The illustrated control systems are just examples, and a wide variety of other control systems, in at least some examples, are used to control other controllable subsystems differently.

Sensors 824 include radar sensor(s) 826, which, in one example, includes any radar sensors 302, 602, 604, 702, or 704 described in relation to other Figures. Sensor 824 also includes an image sensor 828, which in one example includes image sensing device 202 described in relation to other figures. As indicated by block 830, other sensors are also included, illustratively encompassing at least a range of sensor types configured to provide data about the environment in which mobile work machine 102 is operating.

Row alignment control system 104, as shown in FIG. 8, comprises several interconnected components, each contributing to the overall functionality of row alignment control system 104. A crop detection component 864 processes radar data from radar sensor(s) 826 and/or image sensor 828. Crop detection component 864 illustratively analyzes the received data to identify and distinguish a location of individual crops and crop rows, for example, crops 206 and crop rows 208, 210, 308, and 310. In one example, crop detection component 864 is equipped with variables to support programmatic calculations, such as the number of crop rows to expect, an indication of an assumed currently aligned state, etc., of crop detection component 864.

Working in tandem with crop detection component 864, a data enhancement component 866, in one example, further processes the data received from radar sensor(s) 826 and image sensor 828 to support programmatic determinations, illustratively including determinations of distances to crop rows, examples of which were discussed in relation to graphs 334, 336, 426, 502, 614, 624, 640, and 648. In another example, crop detection component 864 and data enhancement component 866 are configured to support similar determinations based on image data from the image sensor 828, depending upon environmental conditions. Crop detection component 864 and data enhancement component 866 together are illustratively configured to provide data from (or at least data based on data from) radar sensor(s) 826 and image sensor 828 to support a determination of a magnitude and direction of a shift in crops rows, examples of which have been described.

An asynchrony detection component 868 is illustratively configured to process data from crop detection component 864 and/or data enhancement component 866 and utilize the data programmatically to identify a pattern indicative of a misalignment between mobile work machine 102 and the crop rows (e.g., crop rows 208, 210, 308, 310). An offset determination component 870 illustratively is configured to programmatically process the same data to quantify the magnitude and direction of any misalignment. A compensation estimation component 872 illustratively takes the magnitude and direction and generates a corresponding corrective action. In one example, compensation estimation component 872 is configured to factor in variables, such as (but not limited to) a current speed and the heading of mobile work machine 102.

Finally, output generation component 874 receives the corresponding corrective action from compensation estimation component 872 and formulates appropriate actionable control signals. These signals are then sent to the appropriate systems or controllable subsystems, such as steering subsystem 840 propulsion subsystem 842, and/or operator interface mechanisms 822, to facilitate the execution of corrective maneuvers. Output generation component 874, in one example, interfaces with operator interface controller 852 to provide visual feedback or alerts to operator 810 about an alignment status and/or any corrections being made. In some examples, row alignment control system 104 also comprises other items, as indicated by block 876.

Accordingly, row alignment control system 104 allows for continuous monitoring and adjustment of the position of mobile work machine 102 relative to the crop rows (e.g., crop rows 208, 210, 308, 310). Row alignment control system 104 interfaces with row alignment detection hardware 106. Row alignment control system 104 can handle various field conditions, from early crop growth stages where visual detection is sufficient to later stages where radar penetration becomes essential. The ability to fuse data from multiple sensors and process the fused data ensures robust and accurate row alignment, enhancing the efficiency and effectiveness of operations.

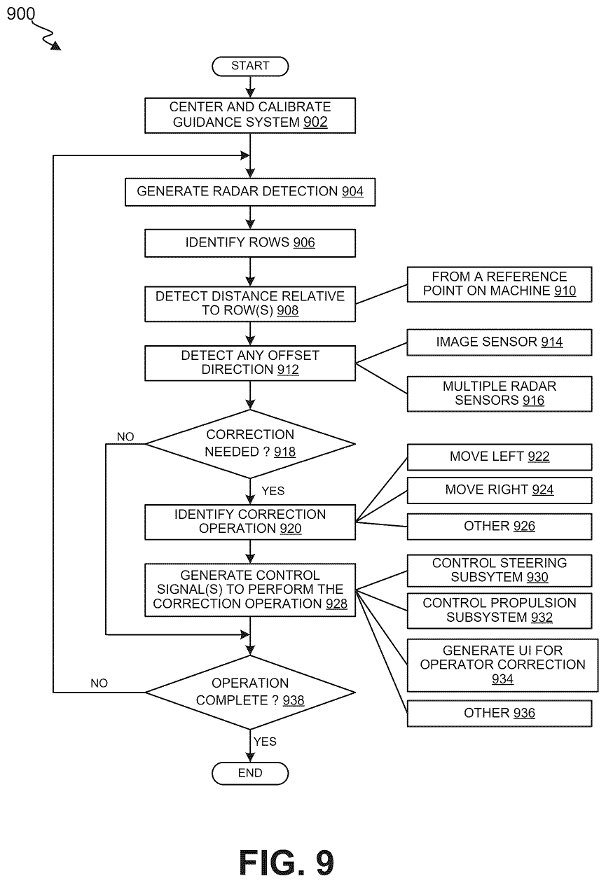

FIG. 9 is a block process diagram that presents an example of crop row alignment process 900. At block 902, crop row alignment process 900 illustratively begin with an initial step of centering and calibrating. In one example, the centering and calibration involve utilizing sensor(s) 824 (FIG. 8) to establish a baseline alignment between mobile work machine 102 and the crop rows, such as crop rows 208, 210, 308, and 310. This baseline alignment provides a reference for subsequent row detection and alignment operations and is illustratively performed automatically, semi-automatically, or manually. Centering and calibration illustratively help to ensure that row alignment control system 104 starts with accurate positional data relative to the crop rows. In some examples, calibration is optional.

The next step, signified by block 904, is to generate radar detection. One example involves activating the radar sensor or sensors that emit radar waves interacting with crops 206, ultimately providing crop position and configuration data. In accordance with block 906, the next step is identifying crop rows from the generated data. In accordance with block 908, the distance to the crop row is determined.

As indicated by block 910, distances are determined relative to a reference point. In one example, the reference point is a point on mobile work machine 102. In one example, the reference point is a central axis of mobile work machine 102, such as central axis 204, depicted at least in FIGS. 2 and 3. In one example, block 910 represents data enhancement component 866 (FIG. 8) processing the radar data to programmatically calculate distances to every single crop row, ensuring that row alignment control system 104 is equipped with information describing the position of mobile work machine 102 relative to the crop rows.

As is indicated by block 912, a determination is made as to whether mobile work machine 102 has deviated from alignment and, if so, in what direction. In accordance with block 914, information from an image sensor is utilized for this purpose, for example, from imaging image sensing device 202. In accordance with block 916, multiple radar sensors, for example, are configured as described in relation to FIGS. 6A and 6B are also or alternatively utilized to provide a basis for detecting a shift.

In accordance with block 918, when a misalignment or shift has been detected, a determination is made as to whether a correction is desired. If no correction is desired, the process returns to block 904 for continued monitoring. If a correction is desired, the process moves to block 920, where row alignment control system 104 is illustratively configured to identify an appropriate correction operation programmatically. As described, such a determination is illustratively based on the data provided by radar sensor 826 and/or an image sensor 828. As is indicated by block 922, in one example, this means moving mobile work machine 102 to the left. As is indicated by block 924, in another example, this means to move right. As indicated by block 926, other operations are possible depending on the nature of the detected shift or misalignment. Row alignment control system 104 illustratively identifies the magnitude and direction of the desired correction based directly on (or derived from) the data received from the radar sensor and the image sensor, respectively. In one example, the compensation estimation component 872 (FIG. 8) calculates the magnitude and direction of the desired correction based on a determined deviation from the calibrated baseline.

In accordance with block 928, control signals are generated as desired to facilitate the execution of the identified corrective action. These control signals are directed to the relevant system(s) or subsystem(s) of mobile work machine 102 to bring mobile work machine 102 into alignment with the crop rows, such as the steering subsystem at block 930 to steer mobile work machine 102, or the propulsion subsystem at block 932 to propel mobile work machine 102. In another example, at block 934, a user interface (UI) signal is generated and sent to cause an operator to be informed or to perform desired actions. In accordance with block 936, control signals are otherwise utilized to facilitate an appropriate action. As indicated by block 938, the process then loops back to block 904 if the operation is incomplete. This iterative loop allows for continuous monitoring and adjustment, ensuring mobile work machine 102 remains aligned with crops 206 during operation. Alternatively, as indicated in block 938, the process proceeds to end if the operation is complete.

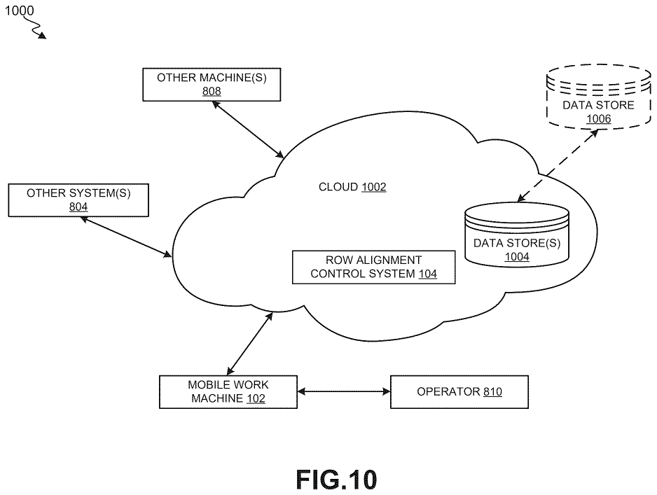

FIG. 10 is a block diagram showing one example of mobile work machine 102 deployed in a remote server architecture 1000. For example, remote server architecture 1000 illustratively provides computation, software, data access, and storage services that do not entail end-user knowledge of the physical location or configuration of the system that delivers the services. In various examples, remote servers illustratively deliver services over a wide area network, such as the Internet, using appropriate protocols. For instance, remote servers illustratively deliver applications over a wide area network and be accessed through a web browser or any other computing component. In some examples, software or components are shown in FIG. 8, and the corresponding data are stored on servers at a remote location. The computing resources in a remote server environment, in some examples, are consolidated at a remote data center location, or they can be dispersed. In some examples, remote server infrastructures deliver services through shared data centers, even though they appear as a single access point for the user. Thus, the components and functions described herein can be provided from a remote server at a remote location using a remote server architecture. Alternatively, they can be provided from a conventional server or installed on client devices directly or in other ways.

In the example shown in FIG. 10, some items are similar to those shown in FIG. 8 and are similarly numbered. FIG. 10 specifically shows that row alignment control system 104 and one or more functionally connected data store(s) 1004 are located at a remote server location, shown in the Figure as cloud 1002. Therefore, mobile work machine 102 accesses those systems through cloud 1002 (i.e., the remote server location).

FIG. 10 also depicts another example of a remote server architecture. FIG. 10 shows that some elements of FIG. 8 are also contemplated as being disposed of in cloud 1002 while others are not. By way of example, one or more data store(s) 1006 can be disposed of at a location separate from cloud 1002 and accessed through the remote server at a remote location. Regardless of location, one or more data store(s) 1006 can be accessed by mobile work machine 102, through a network (either a wide area network or a local area network), one or more data store(s) 1006 can be hosted at a remote site by service, can be provided as a service, or accessed by a connection service that resides in a remote location.

In one example, the data (which, as has been described, is stored in substantially any location) is intermittently accessed by or forwarded to interested parties. Such interested parties include other machines(s) 808 and other system(s) 804, as described in relation to FIG. 8. In one example, the data transferred to such interested parties includes some or all of the output generated by row alignment control system 104. Furthermore, the transfer illustratively occurs across physical carriers instead of, or in addition to, electromagnetic wave carriers. In one example, a second mobile work machine (e.g., a machine that follows mobile work machine 102) is in the same field as mobile work machine 102, and an automated information collection system is established between the two. As the second mobile work machine comes close to mobile work machine 102, the second mobile work machine automatically collects information from mobile work machine 102 (or transfers information to mobile work machine 102) using any type of communications connection, such as an ad-hoc wireless connection. In some examples, such information transfers are with other system(s) 804, such as a handheld mobile device, drones, harvester attachments, etc.

It is also to be noted that the elements of FIG. 8, or portions, can be disposed of on various devices. Some of those devices include servers, desktop computers, laptop computers, tablet computers, or other mobile devices, such as palm top computers, cell phones, smartphones, multimedia players, personal digital assistants, etc.

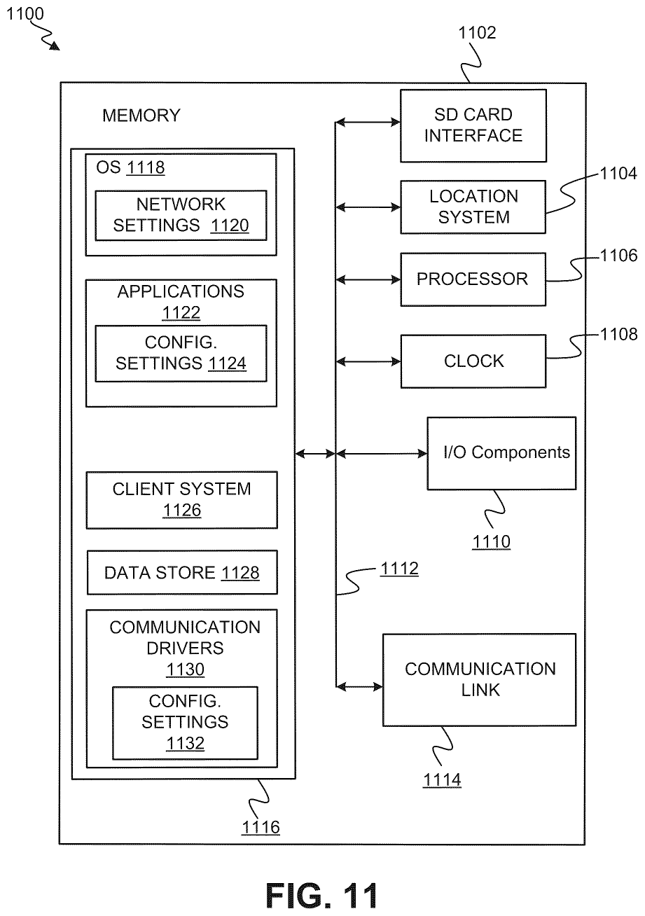

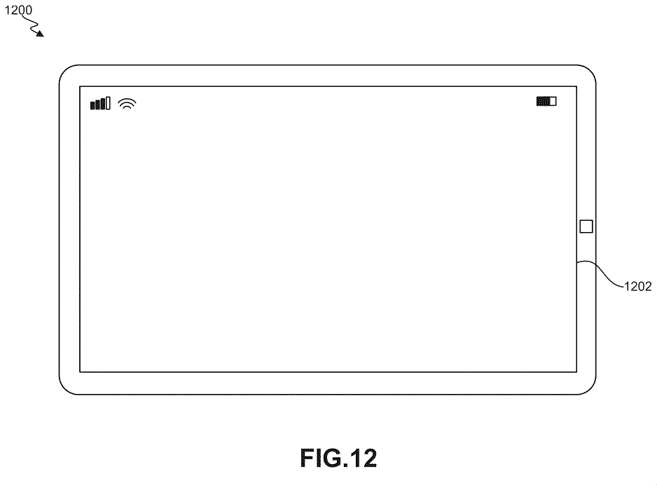

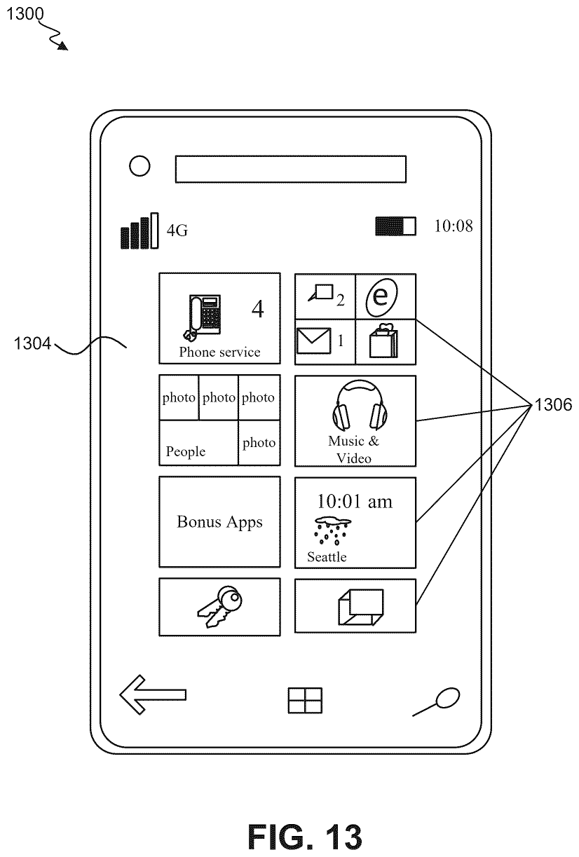

FIG. 11 is a general block diagram of one illustrative example of a hand-held or mobile computing device that can be used as a user's or client's hand-held device 1100, where the present system (or parts thereof) can be deployed. For instance, a mobile device can be deployed in operator compartment 108 of mobile work machine 102 to generate, process, or display some or all of the output generated by row alignment control system 104. FIGS. 12 and 13 are examples of handheld or mobile devices.

FIG. 11 illustrates examples of components of a hand-held device 1100 that can run some components, as shown in FIG. 8, that interact with them, or both. In hand-held device 1100, a communication link 1114 allows hand-held device 1100 to communicate with other computing devices and, under some examples, provides a channel for automatically receiving information, such as by scanning. Examples of communication link 1114 include allowing communication through one or more communication protocols, such as wireless services used to provide cellular access to a network and protocols that provide local wireless connections to networks.

In other examples, applications can be received on a removable Secure Digital (SD) card connected to an SD card interface 1102. SD card interface 1102 and communication link 1114 communicate with a processor 1106 (which also illustratively embodies processors or servers from previous Figures) along a bus 1112 that is also connected to memory 1116 and input/output (I/O) components 1110, as well as a clock 1108 and a location system 1104.

I/O components 1110, in one example, are provided to facilitate input and output operations. I/O components 1110 for various examples of hand-held device 1100 include input components such as buttons, touch sensors, optical sensors, microphones, touch screens, proximity sensors, accelerometers, orientation sensors, and output components such as a display device, a speaker, and or a printer port. Other I/O components 1110 are applicable as well.

Clock 1108 illustratively comprises a real-time clock component that outputs a time and date. Clock 1108 also, illustratively, provides timing functions for processor 1106.

Location system 1104 illustrates a component that outputs a current geographical location of the hand-held device 1100. This can include, for instance, a global positioning system (GPS) receiver, a LOng RAnge Navigation (LORAN) system, a dead reckoning system, a cellular triangulation system, or other positioning systems. It can also include, for example, mapping software or navigation software that generates desired maps, navigation routes, and other geographic functions.

Memory 1116 stores operating system (OS) 1118, network settings 1120, applications 1122, application configuration settings 1124, client system 1126, data store 1128, communication drivers 1130, and communication configuration settings 1132. Memory 1116 illustratively includes all tangible volatile and non-volatile computer-readable memory devices. In some examples, memory 1116 also includes computer storage media (described below). Memory 1116 illustratively stores computer-readable instructions that, when executed by processor 1106, cause the processor to perform computer-implemented steps or functions according to the instructions. Other components can activate processor 1106 to facilitate the functionality of the other components as well.

FIG. 12 shows one example in which hand-held device 1100 is a tablet computer 1200. In FIG. 12, tablet computer 1200 is shown with a user interface screen 1202. In one example, the user interface screen 1202 is a touch screen or a pen-enabled interface that receives inputs from a pen or stylus. In some examples, tablet computer 1200 also uses an on-screen virtual keyboard. Of course, in other examples, tablet computer 1200 is also attached to a keyboard or other user input device through a suitable attachment mechanism, such as a wireless link or Universal Serial Bus (USB) port. Tablet computer 1200 illustratively receives voice inputs as well.

FIG. 13 shows that hand-held device 1100 is a smartphone 1300. Smartphone 1300 has a touch-sensitive display 1304 that displays icons, tiles, or other user input mechanisms 1306. Users illustratively use user input mechanism 1306 to run applications, make calls, perform data transfer operations, etc. In general, smartphone 1300 is built on a mobile operating system and offers more advanced computing capability and connectivity than a feature phone.

Note that other forms of hand-held device 1100 are possible.

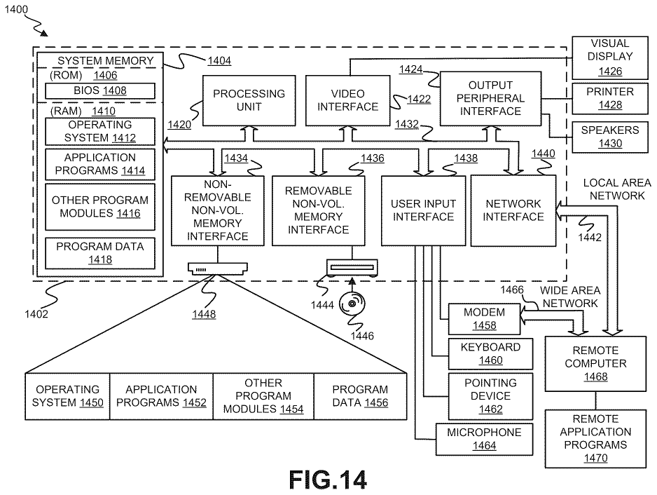

FIG. 14 is one example of a computing environment in which elements of FIG. 8, or parts thereof (for example), are deployable. With reference to FIG. 14, an example system for implementing some examples includes a computing device in the form of a computer 1400. Components of computer 1400 are shown in relation to a conceptual boundary 1402 and include, but are not limited to, a processing unit 1420 (which illustratively comprises processors or servers from previous FIGS.), a system memory 1404, and a system bus 1432 that couples various system components, including system memory 1404 to the processing unit 1420. In one example, system bus 1432 is in the form of a bus structure, including a memory bus or controller, a peripheral bus, and a local bus using various bus architectures. Memory and programs described with respect to FIG. 8 are deployable in corresponding portions of FIG. 14.

Computer 1400 typically includes a variety of computer-readable media. Computer-readable media can be any available media accessed by computer 1400, including volatile and nonvolatile media and removable and non-removable media. By way of example, and not limitation, computer-readable media may comprise computer storage media and communication media. Computer storage media differs from and does not include a modulated data signal or carrier wave. It includes hardware storage media, volatile and nonvolatile, removable and non-removable media implemented in any method or technology for storing information, such as computer-readable instructions, data structures, program modules, or other data. Computer storage media includes but is not limited to random-access memory (RAM), read-only memory (ROM), electrically erasable programmable ROM (EEPROM), flash memory or other memory technology, compact disc (CD)-ROM, digital versatile disks (DVD) or other optical disk storage, magnetic cassettes, magnetic tape, magnetic disk storage or other magnetic storage devices, or any other medium which can be used to store the desired information, and which can be accessed by computer 1400. Communication media may embody computer-readable instructions, data structures, program modules, or other data in a transport mechanism and include any information delivery media. The term “modulated data signal” means a signal that has one or more of its characteristics set or changed in such a manner as to encode information in the signal.

System memory 1404 includes computer storage media in volatile and/or nonvolatile memory, such as read-only memory (ROM) 1406 and random-access memory (RAM) 1410. A basic input/output system (BIOS) 1408, containing the basic routines that help to transfer information between elements within computer 1400, such as during start-up, is typically stored in ROM 1406. RAM 1410 typically contains data and/or program modules that are immediately accessible to and/or presently being operated on by processing unit 1420. By way of example, and not limitation, FIG. 14 illustrates operating system 1412, application programs 1414, other program modules 1416, and program data 1418 as the data and/or program modules stored in RAM 1410.

Computer 1400 may include other removable/non-removable volatile/nonvolatile computer storage media. By way of example only, FIG. 14 illustrates a hard disk drive 1448 reading from or writing to non-removable, nonvolatile magnetic media, an optical disk drive 1444, and a non-volatile optical disk 1446, as examples of the removable/non-removable volatile/nonvolatile computer storage media. Hard disk drive 1448 is typically connected to system bus 1432 through an interface, such as a non-removable memory interface 1434, and optical disk drive 1444 is typically connected to system bus 1432 by a removable memory interface, such as a removable non-volatile memory interface 1436.

Alternatively, or in addition, the functionality described herein is illustratively performed, at least in part, by one or more hardware logic components. For example, and without limitation, illustrative types of hardware logic components include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 14 provide storage of computer-readable instructions, data structures, program modules, and other data for computer 1400. In FIG. 14, for example, hard disk drive 1448 is illustrated as storing an operating system 1450, application programs 1452, other program modules 1454, and program data 1456. These components are illustratively the same as or different from operating system 1412, application programs 1414, other program modules 1416, and program data 1418, stored in RAM 1410.

A user illustratively enters commands and information into computer 1400 through input devices such as a keyboard 1460, a microphone 1464, and a pointing device 1462, such as a mouse, trackball, or touchpad. Other input devices (not shown) include but are not limited to, a joystick, game pad, satellite dish, scanner, etc. These and other input devices are often connected to processing unit 1420 through a user input interface 1438 coupled to system bus 1432. Still, these and other input devices are connectable by other interfaces and bus structures. A visual display 1426 or another type of display device is also illustratively connected to the system bus 1432 via an interface, such as a video interface 1422. In addition to visual display 1426, in some examples, computer 1400 includes other peripheral output devices such as speakers 1430 and printer 1428, connected through an output peripheral interface 1424.

Computer 1400 is operated in a networked environment using logical connections, such as a local area network (LAN) 1442, wide area network (WAN) 1466, and a controller area network (CAN), to one or more remote computers, such as a remote computer 1468.

Computer 1400 is connected to LAN 1442 through a network interface or adapter 1440 when used in a LAN networking environment. When used in a WAN networking environment, computer 1400 typically includes a modem 1458 or other means for establishing communications over WAN 1466, such as the Internet. Program modules may be stored in a remote memory storage device in a networked environment. FIG. 14 illustrates, for example, that remote application programs 1470 reside on remote computer 1468.

It should also be noted that the examples described herein can be combined differently. Parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are examples of implementing the claims.

What is claimed is:

1. A method of controlling a mobile work machine, the method comprising:
receiving data indicative of an area of crops from a first sensor;
receiving data indicative of the area of crops from a second sensor;
identifying, based on the data received from the first and second sensors, a correction operation to bring the mobile work machine into alignment with a plurality of crop rows in the area of crops;
generating a control signal based on the correction operation; and
using the control signal to control the mobile work machine.

2. The method of claim 1, wherein the first sensor is a radar sensor and the second sensor is an image sensing device.

3. The method of claim 1, wherein the first and second sensors are both radar sensors.

4. The method of claim 1, wherein receiving data indicative of the area of crops from the first sensor comprises receiving a distance from a reference point on the mobile work machine to the plurality of crop rows.

5. The method of claim 1, wherein using the control signal to control the mobile work machine further comprises using the control signal to cause a steering subsystem to steer the mobile work machine.

6. The method of claim 1, wherein using the control signal to control the mobile work machine further comprises using the control signal to cause a propulsion subsystem to propel the mobile work machine.

7. The method of claim 1, wherein the using the control signal to control the mobile work machine further comprises using the control signal to generate a user interface.

8. The method of claim 1, wherein the data received from the first sensor and the second sensor comprises a combination of radar and image data.

9. The method of claim 1, wherein identifying the correction operation further comprises identifying the data received from the first sensor as being more reliable than the data received from the second sensor.

10. The method of claim 1, wherein identifying the correction operation further comprises assigning weights to the data received from the first and second sensors.

11. The method of claim 1, wherein identifying the correction operation further comprises identifying a direction of shift based on the data received from the first sensor and identifying a magnitude of shift based on the data received from the second sensor.

12. A mobile work machine, comprising:
two sensors that capture data indicative of an area of crops;
a row alignment control system that identifies a correction operation to bring the mobile work machine into alignment with a plurality of crop rows in the area of crops, wherein the row alignment control system identifies the correction operation based at least in part on a comparison of how a shift in the plurality of crop rows affects data gathered by the two sensors; and
a control system that controls the mobile work machine using a control signal generated by the row alignment control system based on the identified correction operation.

13. The mobile work machine of claim 12, wherein the two sensors are two radar sensors.

14. The mobile work machine of claim 12, wherein the two sensors are a first radar sensor located on one side of the mobile work machine and a second radar sensor located on an opposite side of the mobile work machine.

15. The mobile work machine of claim 12, wherein the two sensors are a radar sensor and an image sensing device.

16. The mobile work machine of claim 12, wherein the comparison is a comparison of distance measurements.

17. A mobile work machine, comprising:
a first radar sensor that provides a distance for each of a plurality of crop rows in an area of crops in front of the mobile work machine;
a second radar sensor that provides a distance for each of a plurality of crop rows in an area of crops in front of the mobile work machine;
a row alignment control system that identifies a correction operation based on a combination of the distances provided by the first and second radar sensors, wherein the row alignment control system generates a control signal based on the identified correction operation; and
a control system that controls the mobile work machine using the control signal.

18. The mobile work machine of claim 17, wherein the first radar sensor is located on a first side of the mobile work machine and the second radar sensor is located on an opposite side of the mobile work machine.

19. The mobile work machine of claim 17, wherein the plurality of crop rows for which the first radar sensor provides the distance is different than the plurality of crop rows for which the second radar sensor provides the distance.

20. The mobile work machine of claim 17, wherein the plurality of crop rows for which the first radar sensor provides the distance is the same as the plurality of crop rows for which the second radar sensor provides the distance.
